(19) United States
(12) Patent Application Publication
(10) Pub. No.: US 2008/0271700 A1
(43) Pub. Date: Nov. 6, 2008

(54) CYLINDER HEAD AND PRODUCTION METHOD FOR A CYLINDER HEAD

(75) Inventor: Jan ZIMMERMANN, Mainz (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/113,832

(22) Filed: May 1, 2008

(30) Foreign Application Priority Data
May 4, 2007 (DE) 102007020927.6

(51) Int. Cl. F02F 11/00

(52) U.S. Cl. 123/193.3; 29/888.06

(57) ABSTRACT

A cylinder head for an internal combustion engine is provided for a motor vehicle. The cylinder head includes, but is not limited to a flow channel, which can be connected to a cylinder. An air duct for injecting gas into the flow channel is connected to the flow channel via a connection channel. The air duct is produced by means of casting and cylinder head provides for a good secondary air injection by means of a simple production.

### CROSS-REFERENCE TO RELATED APPLICATION

This application claims priority to German Patent Application No. 102007020927.6, filed May 4, 2007, which is incorporated herein by reference in its entirety.

### TECHNICAL FIELD

The invention relates to a cylinder head for an internal combustion engine, in particular of a motor vehicle such as a hybrid motor vehicle.

### BACKGROUND

To supply a cylinder of an internal combustion engine with fresh air or to discharge the exhaust gas, provision is made in the cylinder head in each case for a flow channel for the exhaust gas discharge and for the fresh air supply, respectively. To improve the combustion in the cylinder, it can be advantageous to additionally supply air, for example exhaust gas, to the fresh air supply. It can furthermore be advantageous to supply additional fresh air to the exhaust gas, so as to improve a subsequent exhaust gas treatment. To provide for this secondary air injection, it is known from DE 199 40 010 A1 to provide an air duct in the cylinder head by means of machining, that is, by means of drilling. The air duct is connected to the flow channel via a connection duct so that air can be blown into the flow channel from the air duct.

It is a disadvantage of such a cylinder head that the air duct is relatively long so that the production is time-consuming and cost-intensive. To be able to embody the drilled air duct it is furthermore necessary to provide sufficient material during the construction of the cylinder head. In particular, it must be considered hereby that the air duct does not intersect any other ducts, for example oil supply ducts.

It is at least one object of the invention to create a cylinder head for an internal combustion engine, which enables a secondary air injection by means of a simple construction. In addition, other objects, desirable features, and characteristics will become apparent from the subsequent summary, detailed description and the appended claims, taken in conjunction with the accompanying drawings and this background.

According to an embodiment of the invention, the solution of the at least one object takes place with a cylinder head for an internal combustion engine of a motor vehicle. The cylinder head includes, but is not limited to a flow channel that can be connected to a cylinder for the exhaust gas discharge or fresh air supply. The cylinder head also includes, but is not limited to a casted air duct that is connected to the flow channel via a connection duct for injecting gas, in particular exhaust gas, fresh air or crankshaft gases into the flow channel,

The cylinder head according to an embodiment of the invention for an internal combustion engine, in particular of a motor vehicle or hybrid engine, encompasses a flow channel, which can be connected to a cylinder. The flow channel can serve the purpose of discharging exhaust gas or of supplying fresh air. An air duct for injecting gas, in particular exhaust gas, fresh air or crankshaft gases (e.g. blowby) into the flow channel is connected to the flow channel via a connection channel. According to the embodiment of the invention, the air duct is produced by means of casting (i.e., a casted air duct).

Due to the fact that the air duct is provided as early as in response to the primary shaping production of the cylinder head, it is no longer required to produce the air duct by means of drilling from solid material. Furthermore, it is thus possible to save material. A core, which is subjected to hardly any requirements with reference to its geometry, can be used in response to the casting of the cylinder head for the purpose of embodying the air duct. In particular, it is possible to use a core, which leads to a meandered, bent and/or spiraled air duct. It is thus possible for the air duct to be capable of being guided past other installed equipment of the cylinder head. This leads to a particularly compact design of the cylinder head, whereby the weight of the internal combustion engine decreases and the CO₂ discharge of a motor vehicle decreases and a CO₂ reduction is attained.

Preferably, the air duct encompasses at least one bent section so that, for example, provision can be made in the vicinity of the air duct for a bore in the cylinder head. Within the bent section, the air duct defines a bend. Provision can be made within this bend for a bore or other installed equipment of the cylinder head outside the air duct. Due to its embodiment, the air duct can thus be guided past the other installed equipment. In the region of the bent section, the air duct can, for example, be guided past an oil supply duct, which is still to be produced by means of drilling.

In a preferred embodiment, the cylinder head encompasses a cooling duct for cooling the cylinder. The cooling of the cylinder in particular also comprises the cooling of combustion chamber and/or valve seats and/or spark plug and/or other installed equipment, which are arranged so as to be adjacent to the cylinder, which are thermally connected to the cylinder, for example by means of heat conduction. The cooling duct can in particular also be produced by means of casting. In particular in the assembled state of the cylinder head, the cooling duct is arranged between the air duct and the cylinder. By means of the cooling duct, cooling water, for example, can be guided into the vicinity of the cylinder so as to cool the cylinder. The cooling duct can encompass one cooling chamber, for example, which at least partially encloses the cylinder at its jacket surface. Due to the fact that the cooling duct can be arranged between the air duct and the cylinder, the cooling duct can be guided particularly close to the cylinder. In particular, it is possible for the cooling duct to flow around the cylinder at least in a partial region at its jacket surface. For this purpose, the cooling duct can branch out in the region of the cylinder, wherein the individual branchings can flow around the cylinder in a substantially half shell-shaped manner, wherein the two half shell-shaped branchings can embody a cooling chamber, which can have a large volume as compared to the remaining cooling duct, so as to avoid a high temperature increase in response to the cooling of the cylinder. For this purpose, the cooling duct is guided in a substantially half shell-shaped manner at a first peripheral side of the cylinder and along a substantially half shell-shaped second peripheral side of the cylinder, which is connected to the first peripheral side. Due to the fact that the air duct can be embodied in a virtually arbitrary manner, the shape of the cooling duct can also be chosen so as to be optimal, without having to accept disadvantages at an oil chamber of the internal combustion engine. In particular, the cooling duct can be optimized in a streamlined manner so as to specifically guide the coolant flow to previously defined regions of the cylinder.

Due to the freedom in the geometric embodiment of the air duct, it is possible, in particular, to inject air as close as possible on the cylinder. In particular, the flow channel encompasses a connection opening for connecting the flow channel to the cylinder. Furthermore, the flow channel can encompass a valve opening for arranging a valve and for force fitting a valve guide, respectively. By means of the valve, the connection opening, for example, can be closed and opened. Preferably, the connection duct, which can in particular be produced by means of casting, discharges into the flow channel between the connection opening and the valve opening. The flow channel can thus discharge into the flow channel particularly close to the cylinder and can preferably merge into the connection opening. For this purpose, the flow channel can affect the connection opening, for example, substantially in axial direction. Due to the fact that the connection duct ends particularly close to the connection opening, the connection duct can be produced in a particularly simple manner by means of drilling, if necessary, in that the connection channel is drilled from the valve opening. A core, on which the core for the air duct can support itself, can be used for producing the connection duct, in particular when the connection duct is produced by means of casting. Damage to the core during the casting process is thus avoided reliably.

Preferably, the air duct can be connected to a plurality of cylinders, for example four cylinders, in particular to all of the cylinders of the internal combustion engine. It is thus sufficient to provide exactly one air duct for the exhaust gas supply and/or exactly one air duct for the fresh air supply in the cylinder head. More preferably, the cylinder head encompasses one air duct for the exhaust gas supply, as is described above, as well as one air duct for the fresh air supply, as is described above. For this purpose, the air duct is connected to at least one flow channel, which is embodied as an exhaust duct. Furthermore, provision is made for a further air duct, which is connected to at least one further flow channel, which is embodied as an inlet duct.

The embodiment of the invention furthermore relates to an internal combustion engine, for example for a motor vehicle, which encompasses a cylinder block comprising at least one cylinder. The cylinder block is connected to a cylinder head, which can be embodied and further developed as described above. The cylinder is cooled in particular by means of a cooling duct, which flows around the cylinder in the region of the cylinder block and which is at least partially embodied by means of the cylinder head.

The embodiment of the invention furthermore relates to a method for producing a cylinder head, which can be embodied and further developed as described above. Provision is hereby initially made for a cast for the cylinder head. Subsequently, an air duct core for embodying the air duct is arranged, wherein the air duct core is in particular at least partially bent. The air duct core is held by the cast at a first front face and at a second front face. Subsequently, the cast is filled with a casting material, in particular cast iron, aluminum or the like. Subsequently, the casting material cools until it solidifies. Finally, the air duct core is removed by means of milling, for example, so that the cylinder head according to an embodiment of the invention is produced. More preferably, the connection duct cores, which are connected to the air duct core, are arranged in the cast for embodying the connection duct in the cast. The connection duct cores do not only serve the purpose of embodying the connection duct, but also to support the air duct core.

### BRIEF DESCRIPTION OF THE DRAWINGS

The present invention will hereinafter be described in conjunction with the following drawing figures, wherein like numerals denote like elements, and

FIG. 1 shows a diagrammatic, perspective, simplified view of a part of the cylinder head according to an embodiment of the invention;

FIG. 2 shows a diagrammatic, perspective, simplified view of the cylinder head comprising the components illustrated in FIG. 1;

FIG. 3 shows a diagrammatic, perspective rear view of the cylinder head; and

FIG. 4 shows a diagrammatic, perspective sectional view of the cylinder head.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

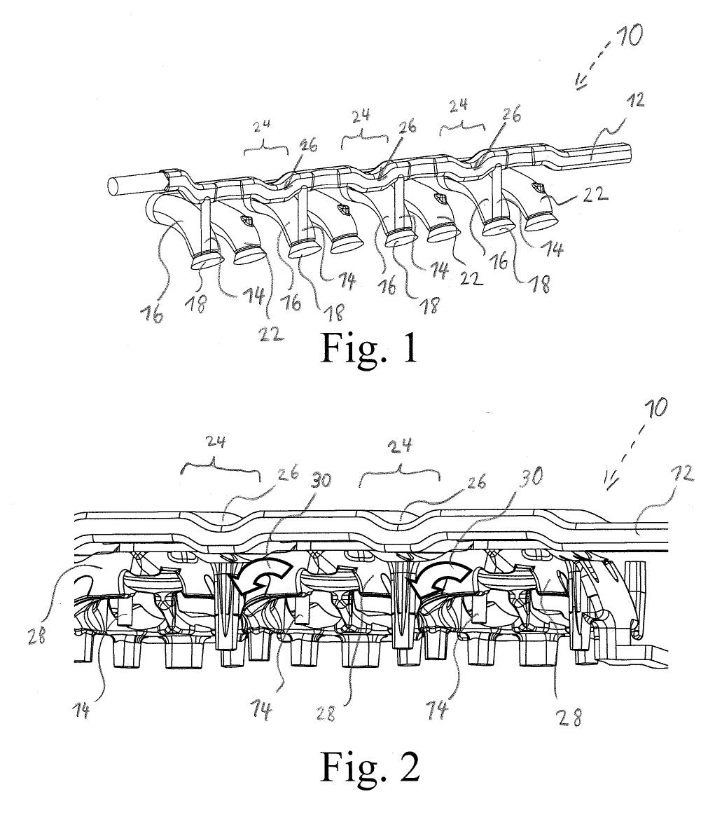

The cylinder head illustrated in FIG. 1 in a highly simplified manner, only illustrates an air duct 12, which is connected in each case to a flow channel 16, which is embodied as an exhaust gas duct, via a total of four connection ducts 14. The flow channel 16 can be connected to a cylinder 20 via a connection opening 18. Furthermore, provision is made for further flow channels 22 for the fresh air supply, to which a further non-illustrated air duct can be connected in each case.

The air duct 12 encompasses a plurality of bent sections 24, through which in each case a bend 26 is defined. Within the bent section 24, these bends 26 releases a region, in which a bore or other installed equipment can be arranged outside the air duct 12 without the air duct 12 encompassing an interfering geometry.

A cooling duct 28 can be arranged between the air duct 12 and the cylinder 20, by means of which cooling water, for example, can be guided to the cylinders 20. The cooling duct 28 illustrated in FIG. 2 in a sectional view conveys cooling water along the arrow 30 towards the cylinder 20.

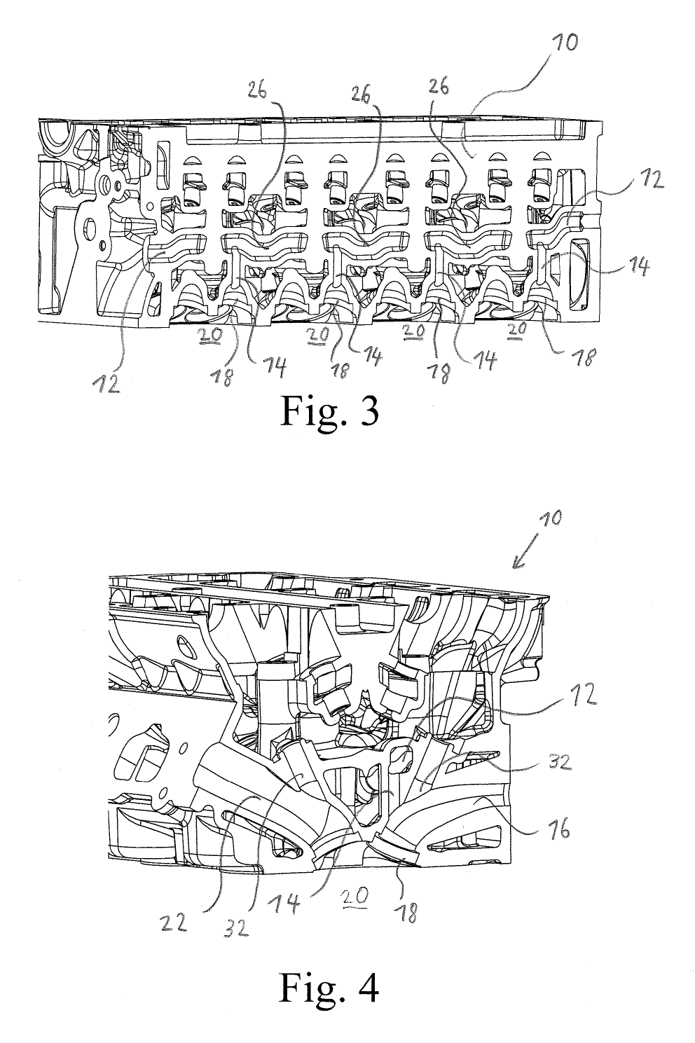

As can be seen in particular in FIG. 3, the geometry which can substantially be embodied freely of the air duct 12, which is produced by means of casting, provides for a particularly compact design of the cylinder head 10. At the same time, the bends 26 provide for the accessibility to further components of the cylinder head 10.

It is possible, in particular, to supply the air from the air duct 12 to the flow channel 16 as close as possible to the cylinder 20 (FIG. 4). For this purpose, the connection duct 14 can discharge in the flow channel 16 between the connection opening 18 and a valve opening 32, into which a valve guide can be force fitted.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A cylinder head for an internal combustion engine of a motor vehicle, comprising:
a flow channel that can be connected to a cylinder; and
a casted air duct that is connected to the flow channel via a connection duct.

2. The cylinder head according to claim 1, wherein the casted air duct air duct encompasses a bent section for arranging a bore outside the casted air duct and substantially within a bend defined by the bent section.

3. The cylinder head according to claim 1, further comprising a casted cooling duct coupled between the casted air duct and the cylinder for cooling the cylinder.

4. The cylinder head according to claim 3, wherein the casted cooling duct is configured to flow around the cylinder and is guided at a substantially half shell-shaped first peripheral side of the cylinder and at a substantially half shell-shaped second peripheral side of the cylinder, which is connected to the half shell-shaped first peripheral side.

5. The cylinder head according to claim 1, wherein the flow channel encompasses a valve opening for arranging a valve and a connecting opening for connecting the flow channel to the cylinder and in that the connection duct, which is produced in particular by means of casting, discharges into flow channel between a connection opening and the valve opening.

6. The cylinder head according to claim 1, wherein the casted air duct can be connected to four cylinders.

7. The cylinder head according to claim 1, wherein the casted air duct is connected to at least one flow channel, which is embodied as an exhaust duct and in that provision is made for a further air duct, which is connected to at least one further flow duct, which is embodied as an inlet duct.

8. An internal combustion engine comprising:
a cylinder block;
a cylinder encompassed by the cylinder block; and
a cylinder head connected to the cylinder, the cylinder head comprising a flow channel that can be connected to cylinder and a casted air duct that is connected to the flow channel via a connection duct.

9. A method for producing a cylinder head, comprising the steps of:
providing a cast for the cylinder head;
arranging an air duct core that is at least partially bent for embodying an air duct, and held by a cast at a first front face and at a second front face;
filling the cast with a casting material;
cooling the casting material until it solidifies; and
removing the air duct core.

10. The method according to claim 9, wherein connecting duct cores connected to the air duct core are arranged for embodying the connection duct in the cast for supporting the air duct core.
